(19) United States
(12) Patent Application Publication
(10) Pub. No.: US 2009/0027913 A1
(43) Pub. Date: Jan. 29, 2009

(54) Lighting Arrangement for an Automotive Vehicle

(75) Inventor: Detlef Baranski, Recklinghausen (DE)

Correspondence Address: BUCHANAN, INGERSOLL & ROONEY PC, POST OFFICE BOX 1404, ALEXANDRIA, VA, 22313-1404, US

(73) Assignee: PILKINGTON AUTOMOTIVE DEUTSCHLAND GMBH, Witten (DE)

(21) Appl. No.: 11/992,226

(22) PCT Filed: Sep. 19, 2006
(86) PCT No.: PCT/EP2006/009083

§ 371 Date: Mar. 19, 2008

(30) Foreign Application Priority Data
Sep. 20, 2005 (GB) 0519156.4

(51) Int. Cl. B60Q 1/30

(52) U.S. Cl. 362/541

(57) ABSTRACT

A lighting array comprising a plurality of lighting modules, each lighting module comprising a substrate having at least one light emitting diode mounted thereon is disclosed. The modules are arranged to radiate light in a substantially parallel manner. At least some of the modules in the array are arranged in a stepwise manner to adapt to the curvature of an automotive glazing. The modules are preferably arranged to form a centre high mount stop lamp.

This invention relates to lighting arrangements for automotive vehicles, and in particular, to high mounted stop lights for automotive vehicles.

Automotive vehicles are provided with lighting arrangements at the rear of the vehicle to warn following drivers of changes in direction and/or speed. These lighting arrangements include stop lamps (brake lights), indicators and reversing lights. It is also a legal requirement in Europe and the USA to provide a third brake light, commonly known as a centre high mounted stop lamp (CHMSL). CHMSLs are provided either at the top or bottom of the rear windscreen or backlight, or, where this is not possible, at the centre of the boot lid or a rear spoiler.

Typically, CHMSLs comprise an array of light emitting diodes (LEDs) activated at the same time as the conventional stop lamps when the brake pedal is depressed. The LED array is fixed on the inside of the rear windscreen or backlight, or individual LEDs may be fixed within the structure of a laminated glazing. The advantage of using CHMSLs is that the light emitted by the LEDs when the brake pedal is depressed is visible through a vehicle, allowing drivers in a queue of traffic to see vehicles slowing, two or three vehicles ahead, when conventional stop lamps are obscured.

EP 1 277 615 A1 discloses a CHMSL comprising a 2-D array of LED chips mounted on a flexible substrate. The substrate is fixed to the inside of a backlight. By providing a 2-D array, the light emitting area is increased, giving better visibility of the CHMSL to drivers following the vehicle. As the substrate is flexible, it allows the array to be fixed onto a curved glazing, and provides a wide spread of light. The spread of light is intended to give maximum visibility of the CHMSL.

In order to provide the necessary wide spread of light, the 2-D array is so large that holes are provided in the substrate to increase the rear visibility of the driver of the vehicle. For glazings with a complex curvature (curvature in both horizontal and vertical directions), such a 2-D array would need to be increased in size to a point where it may obscure the driver's vision, to maintain the intensity and spread of light. The maximum visibility to following drivers comes from an array of LEDs emitting parallel beams of light. As an alternative to a flexible substrate, a flat substrate may be used, where the LEDs mounted on the flat substrate emit parallel beams of light. However, for complex windscreens, only a relatively short flat substrate can be used. Whilst the flat substrate may have several rows of LEDs, it can only extend over a small portion of the width of the curved glazing. Use of a flat substrate is therefore not an option if a CHMSL that extends across a major portion of the width of the glazing is desired.

There is therefore a need to be able to produce a CHMSL that maximises the amount of parallel beam light emitted by the LEDs, and that may extend across the maximum width possible of the glazing to which it is fixed (without obscuring the field of view of the driver). Furthermore, as glazings for different vehicles have different curvatures, the production of CHMSLs can be time-consuming and costly.

The present invention aims to address these problems by providing a lighting array comprising a plurality of lighting modules, each lighting module comprising a substrate having at least one light emitting diode mounted thereon, the modules being arranged to radiate light in a substantially parallel manner, wherein at least some of the modules in the array are arranged in a stepwise manner to adapt to the curvature of an automotive glazing.

By using a plurality of small lighting modules, a centre high mounted stop light with reduced angular divergence of the emitted light, and that extends across a greater portion of the glazing can be achieved. By increasing the portion of parallel light emitted, the visibility of the lighting array to drivers following a vehicle is increased. The use of the modules allows CHMSLs for glazings of various curvatures to be produced in a more cost-effective and simple manner than previously, as there is no need to manufacture different CHMSLs for different glazings.

At least some of the modules in the lighting array may form a centre high mounted stop lamp. Alternatively or additionally, at least two modules may form a direction indicator light. At least one module may form a reversing light.

Preferably, all of the modules in the lighting array form a centre high mounted stop lamp. All of the modules may be arranged in a stepwise manner. At least two modules may be arranged to overlap. At least two modules may be arranged in an edge-to-edge manner.

Preferably, each module is the same size. Alternatively, the modules are of different sizes. In this case, preferably the modules are arranged in order of decreasing size as the angle of the glazing to the plane of the central module, or the plane which is orthogonal to the longitudinal axis of the vehicle, increases.

Each module may be mounted independently. Each module may be independently electrically controlled. The intensity of the light radiated by the light emitting diodes may be proportional to the braking deceleration of a vehicle. Alternatively, the number of modules illuminated may be proportional to the braking deceleration of a vehicle.

At least one module may carry at least one further functional element. Alternatively, at least one module may additionally carry at least one further functional element. Preferably, the functional element is one of a sensor, a heating element, an antenna or a camera. The substrate of each module may be rigid.

Preferably, the array extends across a portion of the width of the glazing. More preferably, the array extends across the width of the glazing. Alternatively, the array may extend along the height of the glazing.

Preferably, the glazing is a backlight.

A module for use in a lighting array, and an automotive glazing comprising a lighting array of the present invention are also provided.

Embodiments of the invention will now be described by way of example only, and with reference to the accompanying drawings in which:

FIG. 1 is a schematic representation of a known LED stop lamp;

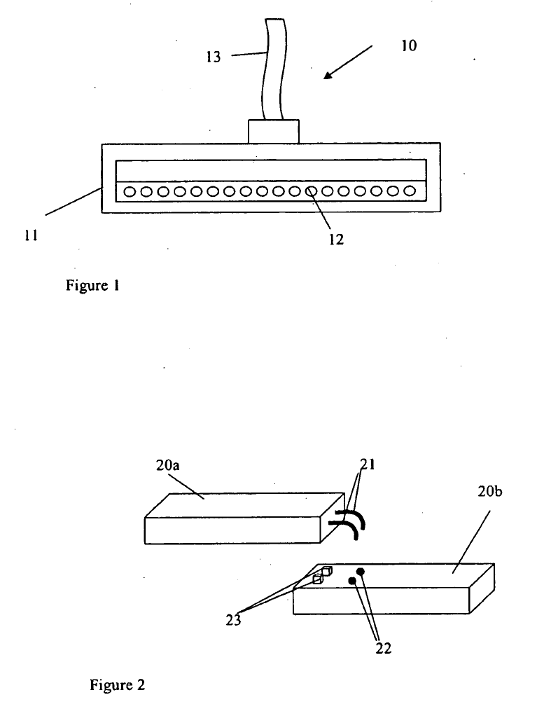

FIG. 2 is a schematic representation of a pair of stop lamp modules in accordance with the invention shown before their assembly;

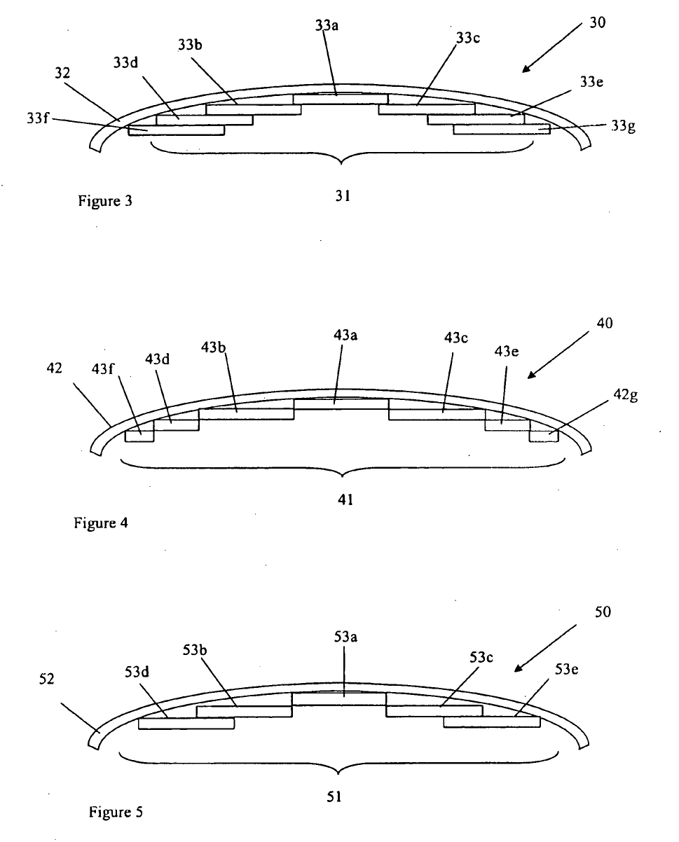

FIG. 3 is a schematic cross section of a CHMSL arrangement in accordance with a first embodiment of the invention;

FIG. 4 is a schematic cross section of a CHMSL arrangement in accordance with a second embodiment of the invention;

FIG. 5 is a schematic cross section of a CHMSL arrangement in accordance with a third embodiment of the invention; and

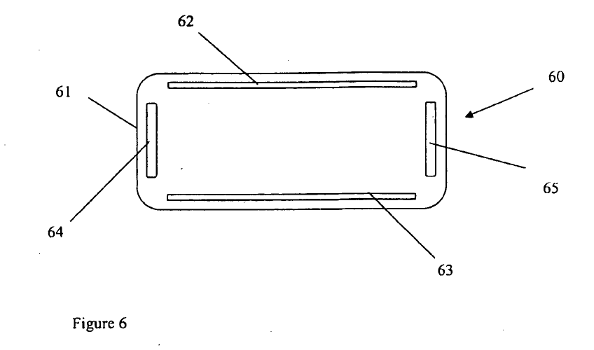

FIG. 6 is a schematic representation of a backlight showing the positioning of a CHMSL of the present invention.

A schematic representation of a known CHMSL is shown in FIG. 1. The CHMSL unit 10 comprises a number of LEDs 12 (light emitting diodes) mounted on a rigid substrate and housed therein. Each LED 12 is connected to the electrical supply of the vehicle in which the CHMSL is fitted by a flexible connector 13. The CHMSL is typically of the order of 20-30 cm in length. The CHMSL is fitted into the vehicle by mounting the substrate on the inside of the backlight or rear windscreen.

FIG. 2 is a schematic representation of two stop lamp modules in accordance with the present invention. Rather than having a single, long, rigid substrate having a plurality of LEDs mounted thereon, a CHMSL made in accordance with the embodiments of the present invention comprises a series of stop lamp modules 20a 20b, which are arranged to form a CHMSL. Each stop lamp module 20a 20b comprises a substrate having at least one LED mounted thereon (not shown). Each module comprises means to form electrical and mechanical connections with adjacent modules. In FIG. 2, a first module 20a is provided with a pair of electrical connectors 21 with which to connect to a pair of terminals 22 on a second module 20b. A pair of protrusions 23 are provided on the second module 20b which are used to form a mechanical connection with the first module 20a. Further mechanical and electrical connections (not shown) are provided on each module 20a 20b for connection with other modules to form a CHMSL. The exact positioning of the connections is determined by the arrangement of the modules, and whether the modules are to be individually electrically controlled, as discussed below.

FIG. 3 is a schematic cross section of a CHMSL in accordance with a first embodiment of the present invention. A backlight 30 is provided with a CHMSL array 31 mounted on a curved sheet of glazing material 32, which may be, for example, toughened or laminated glass. The CHMSL array 31 comprises a plurality of modules 33a-33g arranged across the width of the backlight 30. In the embodiment of FIG. 3, modules of the same length are arranged in a stepwise manner, with some overlap of adjacent modules. Each module is connected to the next using the arrangement of mechanical and electrical connections shown in FIG. 2. In the embodiment shown, the modules are first connected together to form the CHMSL array, which is then fixed to the backlight and held into retaining clips adhered to the glass at each end of the array. The modules may be connected together using mechanical retaining clips or sockets, adhesive, magnetic connectors or a plug and socket arrangement. Alternatively, the modules may be fixed individually to the glazing. Suitable fixing mechanisms include retaining sockets adhered to the glazing material, or the use of adhesive to fix the modules directly to the glazing. In addition, the modules may be connected to each other electrically, with a single connection leading to the electrical power source of the vehicle, or an individual electrical connection for each module may be provided. The mechanical connections between the modules may also form electrical connections.

By arranging the modules in this manner, the light emitted by the LEDs within each module is substantially parallel, and the divergence of the light seen by following drivers is reduced. A large, parallel spread of light is achieved by providing modules across the whole width or portion of the whole width or a portion of the width of the backlight. Where the curvature of the backlight is low, the modules may be arranged in an edge-to-edge manner, particularly where the thickness of the module is less than the overlap distance needed to conform the modules to the curvature of the backlight.

FIG. 4 is a schematic cross section of a CHMSL in accordance with a second embodiment of the present invention. A backlight 40 is provided with a CHMSL array 41 mounted on a curved sheet of glazing material 42. Modules 43a-43g of differing sizes are arranged stepwise in an edge-to-edge manner across the width of the backlight 40. The modules are arranged in order of decreasing size as the angle of the glazing to the plane of the central module, or the plane which is orthogonal to the longitudinal axis of the vehicle, increases. The length of the modules decreases towards the edge of the glazing, even for glazings of constant curvatures. In this embodiment, there is no need to overlap the modules to ensure that they fit within the curvature of the glazing. Again, each module comprises a rigid substrate having at least one LED mounted thereon. The modules may be connected together using a modified version of the electrical and mechanical connections shown in FIG. 2, by providing the mechanical connections at both ends of the module, rather than on a top and bottom surface of the module. Again, the modules can be connected together before fixing to the backlight, with each end of the array held in a retaining socket adhered to the glass. Alternatively, each module may be individually fixed to the glazing material. In addition, the modules may be connected to each other electrically, with a single connection leading to the electrical power source of the vehicle, or an individual electrical connection for each module may be provided.

FIG. 5 is a schematic cross section of a CHMSL in accordance with a third embodiment of the invention. A backlight 50 is provided with a CHMSL array 51 mounted on a curved sheet of glazing material 52, which may be, for example, toughened or laminated glass. The CHMSL array 51 comprises a plurality of modules 53a-53e arranged stepwise across the width of the backlight 50. Rather than a rigid substrate, each module 53a-53e has a semi-flexible substrate having at least one LED mounted thereon. By using a semi-flexible substrate, at least two modules of the same size can be placed edge-to-edge in contact with the glass. This arrangement maximises the flexibility of the CHMSL array (by enabling easy coverage of even very complex curvature glazings) and decreases the divergence of the light emitted by the LEDs compared with known flexible substrates. For regions of the backlight where the curvature of the glazing increases to the extent that it is no longer possible to fit the modules edge-to-edge without an increased divergence in emitted light, the modules can be placed in the overlap arrangement shown in FIG. 3 above. Again, the modules can be connected together before fixing to the backlight, with each end of the array held in a retaining socket adhered to the glass. Alternatively, each module may be individually fixed to the glazing material. In addition, the modules may be connected to each other electrically, with a single connection leading to the electrical power source of the vehicle, or an individual electrical connection for each module may be provided.

The CHMSL array may be fitted within a housing, and the housing fixed to the glass. Alternatively, each module may have a housing, which may be fixed to the glazing material, removing the need for an external housing for the entire array.

In each of the three embodiments described above, all of the modules comprise LEDs that emit red light to form a stop lamp. In a fourth embodiment of the invention, LEDs of different colours can be provided to produce other lights. For example, the outer modules of the CHMSL array may comprise LEDs emitting an orange coloured light, to form indicators. For a CHMSL array where each module is connected to the electrical supply of the vehicle individually, independent control of the indicators and stop lamp may be easily achieved. Alternatively, separate electrical connections may be provided for each differently coloured LED module or group of modules. Additionally or alternatively, a number of modules may be provided with white light emitting LEDs, to form reversing lights.

In addition to carrying LEDs to provide different lighting arrangements across the width of the backlight, the modules may carry at least one of sensors, antennas, heaters, cameras, other electrical circuitry, reflectors or like functional elements. In embodiments where each module is individually electrically controlled, the number of LEDs lit when the brake pedal is depressed can be arranged to indicate the force of braking and/or the braking deceleration of the vehicle. For example, gentle braking may only cause alternate or every third or so on modules to be lit, whereas heavy braking may cause all modules to be lit. Alternatively, if the voltage of each module or the array is controlled, the force of braking and/or the braking deceleration of the vehicle can be indicated by increasing the intensity of the light emitted by each LED.

In each of the embodiments described above, the modules are used to provide a CHMSL or other lighting arrangement across the width of the backlight. However, the glazing forming a backlight may also have a curvature in the vertical direction, and the modules may be used to provide a lighting array that extends along a vertical length of the backlight. Such lighting arrays can comprise any of the arrangements of modules in the embodiments described above.

FIG. 6 is a schematic representation of the positions in which lighting arrays comprising the modules of the present invention can be arranged. A backlight 60 comprises a sheet of glazing material 61, on which lighting arrays may be positioned at the top of the glazing 62 or at the bottom of the glazing 63, and extending across the width of the backlight; or along a first edge 64 or along a second edge 65 extending vertically along the height of the backlight.

1. A lighting array comprising a plurality of lighting modules, each lighting module comprising a substrate having at least one light emitting diode mounted thereon, the modules being arranged to radiate light in a substantially parallel manner, wherein at least some of the modules in the array are arranged in a stepwise manner to adapt to the curvature of an automotive glazing.

2. The lighting array of claim 1, wherein at least some of the modules in the lighting array form a centre high mounted stop lamp.

3. The lighting array of claim 1, wherein at least two modules form a direction indicator light.

4. The lighting array of claim 1, wherein at least one module forms a reversing light.

5. The lighting array of claim 1, wherein all of the modules in the lighting array form a centre high mounted stop lamp.

6. The lighting array of claim 1, wherein all of the modules are arranged in a stepwise manner.

7. The lighting array of claim 1, wherein at least two modules are arranged to overlap.

8. The lighting array of claim 1, wherein at least two modules are arranged in an edge-to-edge manner.

9. The lighting array of claim 6, wherein each module is the same size.

10. The lighting array of claim 6, wherein the modules are of different sizes.

11. The lighting array of any of claim 10, wherein the modules are arranged in order of decreasing size as the angle of the glazing to the plane of the central module, or the plane which is orthogonal to the longitudinal axis of the vehicle, increases.

12. The lighting array of claim 1, wherein each module is mounted independently.

13. The lighting array of claim 1, wherein each module is independently electrically controlled.

14. The lighting array of claim 2, wherein the intensity of the light radiated by the light emitting diodes is proportional to the braking deceleration of a vehicle.

15. The lighting array of claim 2, wherein the number of modules illuminated is proportional to the braking deceleration of a vehicle.

16. The lighting array of claim 1, wherein at least one module carries at least one further functional element.

17. The lighting array of claim 1, wherein at least one module additionally carries at least one further functional element.

18. The lighting array of claim 16, wherein the functional element is one of a sensor, a heating element, an antenna or a camera.

19. The lighting array of claim 1, wherein the substrate of each module is rigid.

20. The lighting array of claim 1, wherein the array extends across a portion of the width of the glazing.

21. The lighting array of claim 1, wherein the array extends across the width of the glazing.

22. The lighting array of claim 1, wherein the array extends along the height of the glazing.

23. The lighting array of claim 1, wherein the glazing is a backlight.

24. A module for use in a lighting array as claimed in claim 1.

25. An automotive glazing comprising a lighting array as claimed in claim 1.

26. (canceled)

27. (canceled)

28. (canceled)
